(19) United States
(12) Patent Application Publication
(10) Pub. No.: US 2009/0160965 A1
(43) Pub. Date: Jun. 25, 2009

(54) Image sensor having a diffractive optics element

(75) Inventors: Noam Sorek, Zikhron-Yaakov (IL); Yaniv Hefetz, Givataim (IL); Sharon Sade, Kfar-Yona (IL)

Correspondence Address: MARTIN D. MOYNIHAN d/b/a PRTSI, INC., P.O. BOX 16446, ARLINGTON, VA, 22215, US

(73) Assignee: Samsung Electronics Co., Ltd., Gyeonggi-do (KR)

(21) Appl. No.: 12/003,181

(22) Filed: Dec. 20, 2007

(51) Int. Cl. H04N 5/228; G02B 27/42; H04N 5/335

(52) U.S. Cl. 348/222.1; 359/558; 348/294; 348/E05.031; 348/E05.091

(57) ABSTRACT

An apparatus for generating a color image that comprises an image sensor having a plurality of light-sensitive elements having a light sensing area, each light-sensitive element is configured for measuring a value corresponding to an intensity of light at the related light sensing area. The apparatus further comprises a diffractive optics element that diffracts impinging light waves. Each one of the impinging light waves is diffracted according to its wavelength toward at least one of the light-sensitive elements. The apparatus further comprises an image processor that generates a color image by arranging the values.

### FIELD AND BACKGROUND OF THE INVENTION

The present invention relates to an optical element, an image sensor, and/or a method for capturing a digital image and, more particularly, but not exclusively to an optical element, an image sensor, and a method for capturing a digital image using light diffraction elements.

Image processing devices, such as digital cameras, are currently among the devices most commonly employed for acquiring digital images. The fact that both image sensors of ever-greater resolution and low cost and consumption digital signal processors are readily available in commerce has led to the development of digital cameras capable, inter alia, of acquiring images of very considerable resolution and quality. Usually, a digital still camera uses an image sensor that includes an array of light-sensitive elements, such as photosensitive cells, for capturing a digital image. In a typical image sensor, a single light-sensitive element is associated with a pixel of the captured digital image.

The typical image sensor is covered by an optical filter that consists of an array of filtering elements each associated with one of the light-sensitive elements. Usually, each filtering element transmits to the associated light-sensitive element the light radiation corresponding to the wavelength of nothing but red (R) light, nothing but green (G) light or nothing but (B) blue light, absorbing only a part of this radiation. For each pixel, it therefore detects only one of the three primary components (R, G, and B) of additive chromatic synthesis. Each one of the light-sensitive elements is usually situated in a cavity, for example as shown in FIG. 1, which is a schematic illustration of three cavities 52 each contains a certain filtering element, such as an B filter 53, a G filter 54, and a R filter 55, which is situated in front of an image sensor 51.

The type of filter employed, which is usually a color filter array (CFA), varies from one maker to another, but the one most commonly used filter is known as a Bayer filter. The Bayer filter is described in U.S. Pat. No. 3,971,065, filed on Mar. 5, 1975, the disclosure of which is incorporated herein by reference. In this filter, the layout pattern of the filtering elements, the so-called Bayer pattern, is identified by the array shown in FIGS. 2 and 3. FIG. 2 depicts a schematic illustration of a Bayer filter mosaic, which is an array of filtering elements 10. FIG. 3 depicts an exploded pictorial representation of the Bayer filter mosaic 10 wherein the green 2 (Y), the red 4 (C1), and the blue 6 (C2) filtering elements are depicted separately. As depicted, the filter pattern is 50% green, 25% red, and 25% blue, hence is also called RGBG or GRGB. As described above, usually each filtering element is associated with a light-sensitive element.

Usually, the light-sensitive elements, which may be referred to as the active part of the sensor, are not attached to one another and therefore do not cover the entire surface of the image sensor. In fact, the light-sensitive elements often cover about a half the total area in order to accommodate other electronics in unsensing areas. In order to utilize the unsensing areas of the image sensor, microlenses, small spherical or aspheric lenslets, may be used. The microlenses direct photons, which would otherwise hit the unsensing areas, toward the photosensitive cells. Usually an array of microlenses is used for an array of photosensitive cells. Each lenslet of the microlens array produces its own output pattern according to its aperture dimensions, surface curvature, and the divergence of the incoming light from the source.

For example, U.S. Pat. No. 6,362,498, published on Mar. 26, 2002, describes a color CMOS image sensor including a matrix of pixels that are fabricated on a semiconductor substrate. A silicon-nitride layer is deposited on the upper surface of the pixels and is etched using a reactive ion etching (RIE) process to form microlenses. A protective layer including a lower color transparent layer formed from a polymeric material, a color filter layer and an upper color transparent layer are then formed over the microlenses. Standard packaging techniques are then used to secure the upper color transparent layer to a glass substrate.

The characteristics of the microlens array may be changed after the image sensor has been fabricated. For example, U.S. Pat. No. 7,218,452, published on May 15, 2007, describes a semi-conductor based imager that includes a microlens array having microlenses with modified focal characteristics. The microlenses are made of a microlens material, the melting properties of which are selectively modified to obtain different shapes after a reflow process. Selected microlenses, or portions of each microlens, are modified, by exposure to ultraviolet light, for example, to control the microlens shape produced by reflow melting. Controlling the microlens shape allows for modification of the focal characteristics of selected microlenses in the microlens array.

### SUMMARY OF THE INVENTION

Some embodiments comprise a light diffraction element, an image sensor, an image capturing device, and a method for capturing a digital image.

According to some embodiment of the present invention, the image sensor comprises an array of light-sensitive elements, such as light-sensitive elements, and a diffractive optics element that has an image plane. The diffractive optics element diffracts light waves that impinge the image plane according to their wavelength. Photons of the light waves are diffracted to impinge light-sensitive elements which have been assigned to measure the intensity of light in a range that covers the wavelength of the light waves. Each one of the colored light waves has a wavelength in a predefined range of the color spectrum. Each one of the light-sensitive elements measures the intensity of the light waves that impinge its light-sensing area. Optionally, the light-sensitive elements are connected to an image processing unit that translates, and/or optionally demosaics, the measurements of the superimposed illuminations to a digital image, such as a joint photographic experts group (JPEG) image.

According to some embodiments of the present invention, the image capturing device comprises an image sensor having a plurality of light-sensitive elements, such as a CCD based sensor and/or a CMOS based sensor. Each one of the light-sensitive elements is designed to measure light waves having a wavelength in a predefined range, for example in the red, green or blue part of the spectrum, and to output a value that corresponds to the measurement. The image capturing device further comprises a diffractive optics element that diffracts impinging light waves toward the light-sensitive elements. Each one of the impinging light waves is diffracted toward a pertinent light-sensitive element that measures light waves having its wavelength. The impinging light waves that would otherwise hit unsensing areas of the image sensor and/or one or more light-sensitive elements, which are designed to measure light having a different wavelength than their wavelength, are measured by a light-sensitive element that is designed to measure them. In such a manner, all or most of the impinging light waves are measured by the light-sensitive elements of the image sensor.

According to some optional embodiments of the present invention, there is a method for capturing a digital image. The method is based on receiving light waves that impinges an image plane, diffracting the impinging light waves, according to their wavelength, toward a reception thereof by light-sensitive elements which are designated to measure light waves in a respective wavelength, and measuring the intensity of the diffracted lights at the receiving light-sensitive elements. These steps allow using the measurements for generating a digital image of the image plane, for example as further described below.

According to one aspect of the present invention there is provided an apparatus for generating a color image. The apparatus comprises an image sensor having a plurality of light-sensitive elements each configured for measuring a value corresponding to an intensity of light at a respective light sensing area, a diffractive optics element configured for diffracting impinging light waves, each the impinging light wave being diffracted according to its wavelength toward at least one of the light-sensitive elements, and an image processor configured for generating a color image by arranging the values.

Optionally, the diffractive optics element having an image plane and configured for diffracting for light waves impinging the image plane, the color image depicting the image plane.

Optionally, the thickness of the diffractive optics element is thinner than 3 millimeters.

Optionally, the diffractive optics element is fixated to the image sensor in front of the plurality of light-sensitive elements.

Optionally, the apparatus further comprises a first set of microlenses for diffracting a light wave that would otherwise impinge an unsensing area toward one of the respective light sensing areas, the first set of microlenses is positioned in a member of group consisting of: between the diffractive optics element and the image sensor or above the diffractive optics element.

More optionally, the apparatus further a second set of microlenses, the first and second sets of microlenses are respectively positioned above and below the diffractive optics element.

Optionally, the apparatus further comprises a mosaic filter for filtering at least some of the impinging light waves according to its wavelength, the mosaic filter is positioned in a member of group consisting of: between the diffractive optics element and the image sensor or above the diffractive optics element. More optionally, the pattern of the mosaic filter is designed according to the diffracting of the diffractive optics element.

Optionally, wherein each the intensity of light having a member of the following group: a wavelength in the red spectrum, a wavelength in the blue spectrum, and a wavelength in the green spectrum.

Optionally, the diffracted impinging light wave is unfiltered.

Optionally, the apparatus is a mobile phone.

Optionally, wherein each the light-sensitive element is assigned to measure intensity of light in a predefined range of color spectrum.

More optionally, each the impinging light wave is centered on a certain wavelength and diffracted toward the proximate light-sensitive element that is designated to measure light in the certain wavelength.

Optionally, the impinging light wave is directed toward unsensing area in the image sensor.

Optionally, the plurality of light-sensitive elements are divided to a plurality of arrays, the diffractive optics element including a grid of sub-elements each designed for diffracting the impinging light wave toward a member of one of the arrays according to the wavelength.

More optionally, the impinging light wave is directed toward a member of a first of the plurality of arrays, the respective sub-element being configured for diffracting the impinging light wave toward another member of the first array, the another member being assigned to measure the wavelength.

According to one aspect of the present invention there is provided a method for capturing a digital image. The method comprises: receiving a light wave impinging an image plane, diffracting the impinging light wave toward a reception thereof by one of a plurality of light-sensitive elements, the impinging light wave being diffracted according its wavelength, measuring an intensity of light having the wavelength at the receiving light-sensitive element, and outputting a digital image of the image plane according to the measurement.

Optionally, each the light-sensitive element is assigned to measure intensity of light in a predefined range of color spectrum.

More optionally, each the impinging light wave is centered on a certain wavelength, the diffracting comprising diffracting the impinging light wave toward the proximate light-sensitive element which is designated to measure light in the certain wavelength.

Optionally, the diffracting comprising diffracting a light wave that would otherwise impinge an unsensing area toward one of the plurality of light-sensitive elements.

According to one aspect of the present invention there is provided an image sensor that comprises an array of a plurality of light-sensitive elements and a diffractive optics element having an image plane and configured for diffracting impinging light waves to form an arrangement of illumination areas on the array. Each illumination area has a wavelength in a predefined range of color and corresponds with a point in the image plane and with at least one of the plurality of light-sensitive elements. The arrangement has a repetitive pattern including a group of the illumination areas having a different the predefined range.

Optionally, the diffractive optics element is fixated in front of the light-sensitive elements.

Optionally, the arrangement is arranged according to a Bayer filter mosaic.

Optionally, the plurality of light-sensitive elements are arranged in a predefined mosaic and configured to measure an intensity of light received in their light sensing area, further comprising an image processing unit configured for generating a digital image by demosaicing the predefined mosaic.

According to one aspect of the present invention there is provided a light deviation array for diffracting a plurality of impinging light waves toward an image sensor having a plurality of light-sensitive elements. The light deviation array comprises a plurality of diffractive optics sub-elements superposed in one-to-one registry on arrays from the plurality of light-sensitive elements, each the diffractive optics sub-element being configured for diffracting a plurality of impinging light waves toward a respective the array. The impinging light wave is directed toward a member of a first of the array, the respective sub-element being configured for diffracting the impinging light wave toward another member of the array.

Optionally, each member of the array is configured for measuring an intensity of light having a member of the following group: a wavelength in the red spectrum, a wavelength in the blue spectrum, and a wavelength in the green spectrum.

Unless otherwise defined, all technical and scientific terms used herein have the same meaning as commonly understood by one of ordinary skill in the art to which this invention belongs. The materials, methods, and examples provided herein are illustrative only and not intended to be limiting.

Implementation of the method and system of the present invention involves performing or completing certain selected tasks or steps manually, automatically, or a combination thereof. Moreover, according to actual instrumentation and equipment of preferred embodiments of the method and system of the present invention, several selected steps could be implemented by hardware or by software on any operating system of any firmware or a combination thereof. For example, as hardware, selected steps of the invention could be implemented as a chip or a circuit. As software, selected steps of the invention could be implemented as a plurality of software instructions being executed by a computer using any suitable operating system. In any case, selected steps of the method and system of the invention could be described as being performed by a data processor, such as a computing platform for executing a plurality of instructions.

### BRIEF DESCRIPTION OF THE DRAWINGS

The invention is herein described, by way of example only, with reference to the accompanying drawings. With specific reference now to the drawings in detail, it is stressed that the particulars shown are by way of example and for purposes of illustrative discussion of the preferred embodiments of the present invention only, and are presented in order to provide what is believed to be the most useful and readily understood description of the principles and conceptual aspects of the invention. In this regard, no attempt is made to show structural details of the invention in more detail than is necessary for a fundamental understanding of the invention, the description taken with the drawings making apparent to those skilled in the art how the several forms of the invention may be embodied in practice.

In the drawings:

FIG. 1 is a schematic illustration of three cavities each contains a known filtering element that is situated in front of an image sensor;

FIG. 2 is a schematic illustration of a known Bayer filter mosaic;

FIG. 3 is an exploded pictorial representation a known Bayer filter mosaic wherein the green, the red, and the blue filtering elements are depicted separately;

FIG. 4 is a sectional schematic illustration of an image capturing device for capturing a digital image, according to one embodiment of the present invention;

FIG. 5 is an exemplary exploded pictorial representation of the image capturing device that is depicted in FIG. 4, according to one embodiment of the present invention;

FIG. 6 is an exemplary exploded pictorial representation of the image capturing device as depicted in FIG. 5, with a grid of diffractive optics sub-elements, according to one embodiment of the present invention;

FIGS. 7, 8, and 9 are schematic illustrations of an exemplary diffractive optics sub-element that is depicted in FIG. 6 and a respective 2×2 array of light-sensitive elements, according to one embodiment of the present invention;

FIG. 10 is a sectional schematic illustration of an image capturing device, as depicted in FIG. 4, with a color filter array, according to an optional embodiment of the present invention;

FIG. 11 is a sectional schematic illustration of an image capturing device, as depicted in FIG. 10, with a set of microlenses, according to an optional embodiment of the present invention;

FIGS. 12A-C are schematic lateral illustrations of a filter, a diffractive optics element, an image sensor, and a set of microlenses, according to some embodiments of the present invention;

FIGS. 12D-12F are schematic lateral illustrations of a diffractive optics element, an image sensor, and a set of microlenses of these components, according to some embodiments of the present invention; and

FIG. 13 is a flowchart of a method for capturing a digital image, according to an optional embodiment of the present invention.

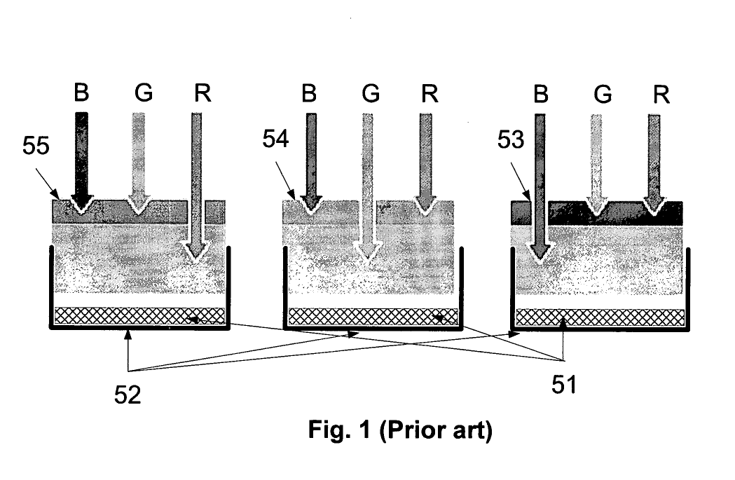

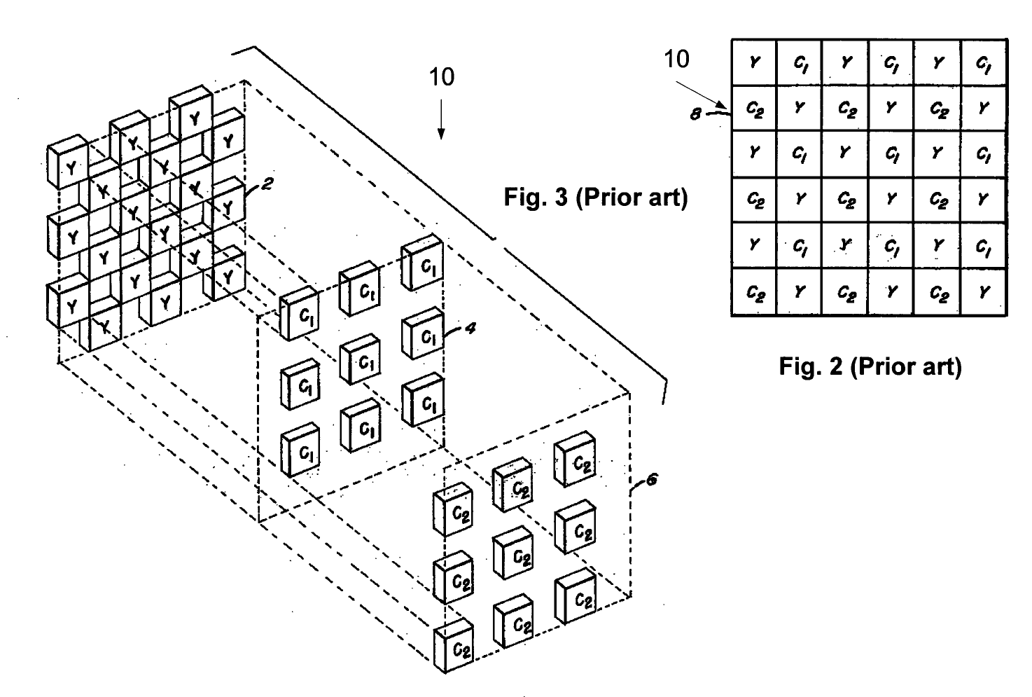

### DESCRIPTION OF EXEMPLARY EMBODIMENTS

Before explaining at least one embodiment of the invention in detail, it is to be understood that the invention is not limited in its application to the details of construction and the arrangement of the components set forth in the following description or illustrated in the drawings. The invention is capable of other embodiments or of being practiced or carried out in various ways. In addition, it is to be understood that the phraseology and terminology employed herein is for the purpose of description and should not be regarded as limiting.

The principles and operation of an apparatus and method according to the present invention may be better understood with reference to the drawings and accompanying description.

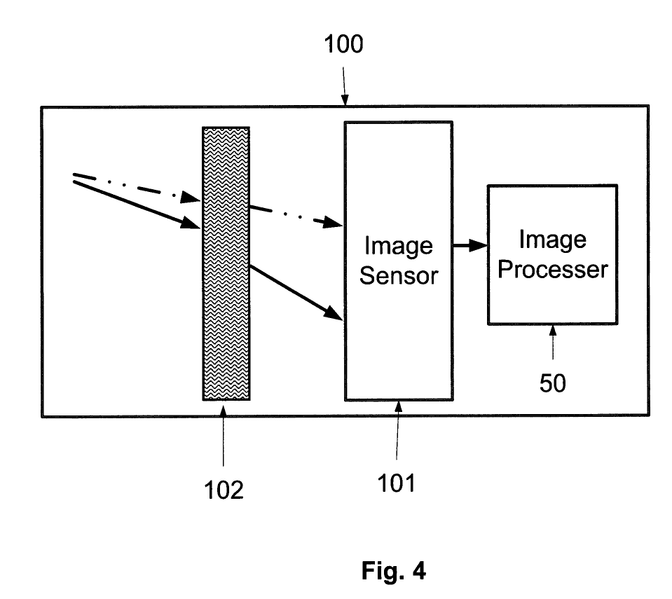

Reference is now made to FIG. 4, which is a sectional schematic illustration of an image capturing device 100 for capturing a digital image, according to one embodiment of the present invention. The image capturing device 100 comprises an image sensor 101, such as a charge-coupled device (CCD) based sensor or a complementary metal-oxide semiconductor (CMOS) based sensor for capturing image data defining a digital image and an image processor 50 for processing the image data to a processed image that is ready for storage and/or display.

Optionally, the image capturing device 100 is a camera unit of a mobile device such as a mobile device, such as a laptop, a webcam, a mobile telephone, a personal digital assistant (PDA), display, a head mounted display (HMD), or the like.

Optionally, the image sensor 101 is a conventional color image sensor, which is formed on an n-type semiconductor substrate having a p-well layer and an array of light-sensitive elements, such as photodiodes or photosensitive cells, which are formed in the p-well layer and optionally covered by a silicon oxide or nitride film. The array of light-sensitive elements measures light waves that impinge the surface of the image sensor and outputs image data optionally in a form of a matrix of colored pixels that corresponds with the measurements of the light-sensitive elements. Light captured by a light-sensitive element may be represented as a pixel, a sub pixel, or a number of pixels. Optionally, each light-sensitive element is associated with a quarter of a pixel.

Optionally, each light-sensitive element has a light sensing area for converting light, such as incident light, into values which are optionally represented as electrical signals. Optionally, the light sensing area of the light-sensitive element is positioned in a cavity.

To create a color image, the image processor 50 apply a digital image process, such as a CFA interpolation, color reconstruction, or demosaicing algorithm, to interpolate a complete image from the data received from the image sensor 101.

The image capturing device 100 further comprises a diffractive optics element (DOE) 102, such as a diffractive optical grating (DOG). The DOE 102, which is optionally placed in front of the image sensor 101, diverts light waves coming therethrough by taking advantage of the diffraction phenomenon.

In an exemplary embodiment of the invention, the DOE 102 is a substrate or an array of substrates on which complex microstructures are created to modulate and to transform impinging light waves through diffraction. The DOE 102 controls the diffraction of the impinging light waves by modifying their wavefronts by interference and/or phase control. As the impinging light waves pass through the DOE 102, their phase and/or their amplitude may be changed according to the arrangement of the complex microstructures. In such a manner, light of a certain wavelength may be diffracted differently than light of a different wavelength. Briefly stated, the DOE 102 is designed to diffract light waves having a certain wavelength in certain angles toward light-sensitive elements, which are assigned to measure light in the certain wavelength or to allow the light wave to pass directly therethrough onto, as further described below.

The DOE 102 diffracts impinging light waves to form an arrangement of colored illumination areas each having a wavelength in a predefined range. The impinging light waves are diffracted in such a manner that the each illumination area is superimposed on one or more of the light-sensitive elements of the image sensor 101. As described above, the light-sensitive elements of the image sensor 101 may be positioned in a cavity. In such an embodiment, the DOE 102 redirects light waves, which would otherwise impinge the walls of the cavity, directly toward the light-sensitive elements.

As further described below, the arrangement has a known CFA pattern layout, such as Bayer mosaic pattern layout.

Optionally, the image processor 50 translates the reception at each one of the light-sensitive elements of the image sensor 101 to image data. Optionally, outputs of each one of the light-sensitive elements are translated to correspond to the intensity of impinging light waves having wavelengths in a predefined range, such as red, blue, and green. Optionally, the translation of the outputs of the light-sensitive elements is patterned according to a known CFA pattern layout, such as the aforementioned Bayer mosaic pattern layout, for example as described in U.S. Pat. No. 3,971,065, filed on Mar. 5, 1975, which is incorporated herein by reference. In such a pattern, 25% of the light-sensitive elements measure red light, 25% of the light-sensitive elements measure blue light, and 50% are light-sensitive elements measure green light. It results in an image mosaic of three colors, where missing image data is optionally interpolated by the image processor 50 to get a complete RGB color image, optionally by demosaicing.

Optionally, the DOE 102 is fixated in front of the image sensor 101. Optionally, as the DOE 102 redirects light in a CFA pattern layout, it used instead of a CFA. In such a manner, the image capturing device 100 may be relatively thin as the DOE 102 is only between 1-3 millimeters, as further described below.

In one embodiment of the present invention, in order to allow each one of the light-sensitive elements to gauge a light waves in a predefined range; the DOE 102 diffracts a light wave having a certain wavelength toward a light-sensitive element that is assigned to receive light waves in a range that includes the certain wavelength. Optionally, each light-sensitive element gauges impinging light waves of the wavelength of nothing but red (R) light, nothing but green (G) light or nothing but (B) blue light. For each light-sensitive element, it therefore detects only one of the three primary components (R, G, and B) of additive chromatic synthesis.

Furthermore, as described above, the light-sensitive elements of the image sensor 1 may not be attached to one another and therefore may not cover the entire surface of the image sensor. Optionally, the light-sensitive elements cover about a half the total area of the image sensor in order to accommodate other electronics in unsensing areas. Optionally, the DOE 102 covers or substantially covers the unsensing areas of the image sensor. In such an embodiment, the DOE 102 redirects impinging light waves, which are directed toward the unsensing areas, toward sensing areas. Optionally, an impinging light wave is redirected according its wavelength, as described above.

In one embodiment of the present invention, the image sensor 101 is designed according to the light waves, which are diffracted from the DOE 102. In such an embodiment, the light sensing elements are positioned to optimize the reception of light waves from the DOE 102.

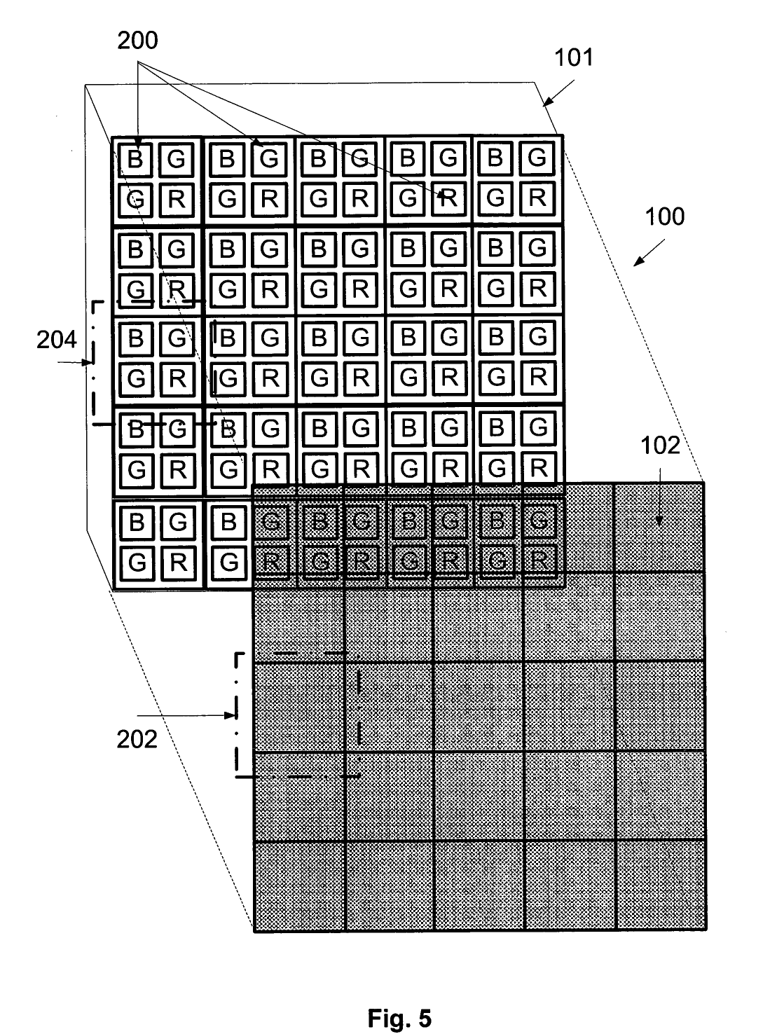

Reference is now made to FIG. 5, which is an exemplary exploded pictorial representation of the image capturing device 100 that is depicted in FIG. 4, according to one embodiment of the present invention. In FIG. 5, light-sensitive elements of the image sensor 101, such as the light-sensitive element that is shown at 200, are patterned according to a Bayer mosaic pattern layout. The exploded pictorial representation shows the DOE 102 that is positioned on front of the light-sensitive elements 200 of the image sensor 101. As described above, the DOE 102 diffracts impinging light waves having a certain wavelength toward photosensitive cells which are assigned to measure light waves having a corresponding wavelength. As described above, the DOE 102 diffracts light waves to form an arrangement of colored illuminations, each in a different range of color spectrum, on the color sensor 101. The area of each illumination, and therefore the area of the mosaic, is a derivative of the distance between the DOE 102 and the plurality of light-sensitive elements of the image sensor 101.

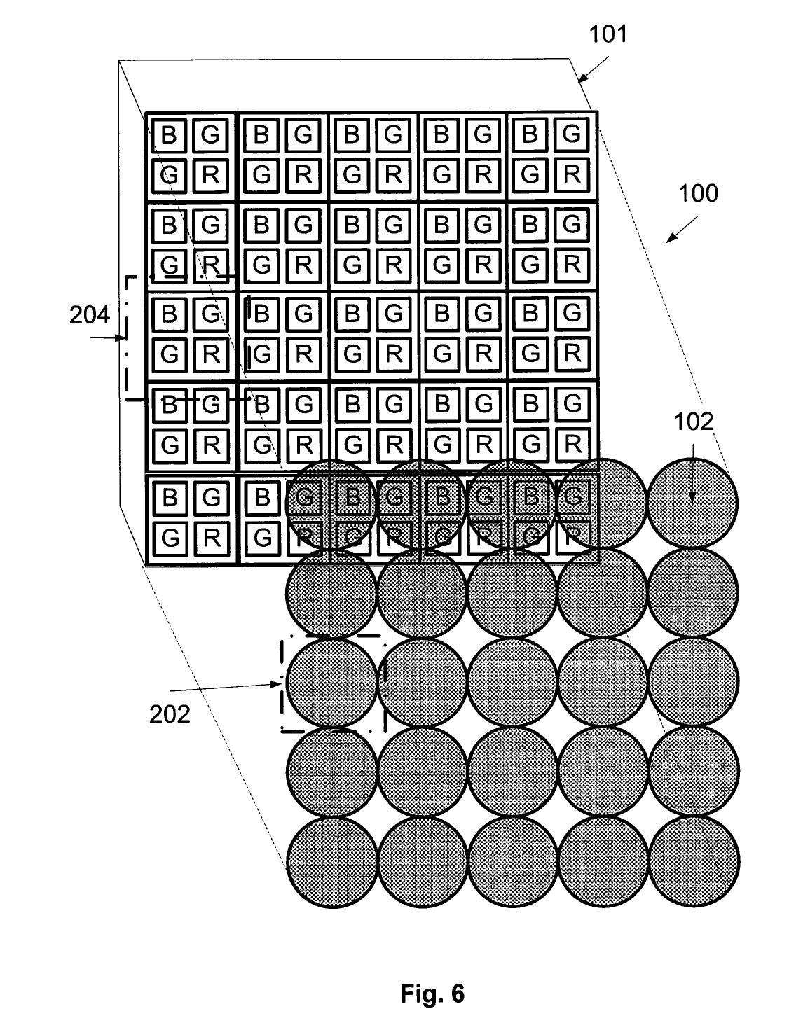

In the embodiment that is depicted in FIGS. 5 and 6, the DOE 102 is a DOG. Optionally, the DOG 102 comprises a number of separate diffractive optics sub-elements, for example as shown in FIG. 6 that is an exemplary exploded pictorial representation of the image capturing device 100 as depicted in FIG. 5, with a grid of diffractive optics sub-elements 150 instead of a monoblock DOE, according to one embodiment of the present invention. Each diffractive optics sub-element, such as 202, is designed for diffracting light among members of a certain array of light-sensitive elements of the image sensor. Optionally, each diffractive optics sub-element 202 diffracts imagining light waves among members of a 2×2 light-sensitive elements array, for example as shown at 204. Optionally, two light-sensitive elements 210 are assigned for measuring green light, one light-sensitive element 211 is assigned for measuring blue light, and one light-sensitive element 212 is assigned for measuring red light. Optionally, the 2×2 light-sensitive elements array is represented as one pixel of the captured image. In such a manner, the light-sensitive element 211 diffracts a light wave having a certain wavelength toward a member of the array that is assigned to measure light waves in a range that covers its wavelength, as described below. As all members of the array are associated with the same pixel or with a proximate pixel, the authenticity of the light origin is kept.

The thickness of the DOG is approximately 1-3 mm. As the DOG 102 is relativity thin, adding it to an image capturing device does not substantially increase the thickness of the image capturing device. The thickness of the DOG 102 is negligible in comparison to the thickness of an optical system that uses geometrical optical elements, such as lenses, beam splitters, and mirrors. As the thickness of the image capturing device 100 is limited, it can be integrated in thin devices and mobile terminals such as a mobile telephone, a laptop, a webcam, a personal digital assistant (PDA), display, and a head mounted display (HMD), or the like. The thickness of the image capturing device allows the positioning of the image capturing device 100 in a manner that the light-sensitive elements face the front side of the thin device or the mobile terminal without increasing the thickness thereof. The front side may be understood as the side with the keypad and/or the screen. In should be noted that the thin device or the mobile terminal are sized to be carried in a pocket size case and to be operated while the user holds it in her hands. Optionally, the pick up side of the light-sensitive elements is parallel to the thin side of the image capturing device 100 and therefore the integrated image capturing device 100 can be used to take pictures of a landscape that is positioned in front of the width side of the mobile terminal.

Furthermore, using the DOG, for diffracting light reduces the need for using filters, such as a color filter arrays (CFAs). Such filters filter out impinging light waves according to one or more of its characteristics, for example according to their wavelength. Such a filtering reduces the light intensity of the image that is captured by the image sensor 101 in relation to an image that it would have captured without the filter. As a quality of an image is determined, inter alia, by the level its light intensity, avoiding the filtering may improve the quality of captured images.

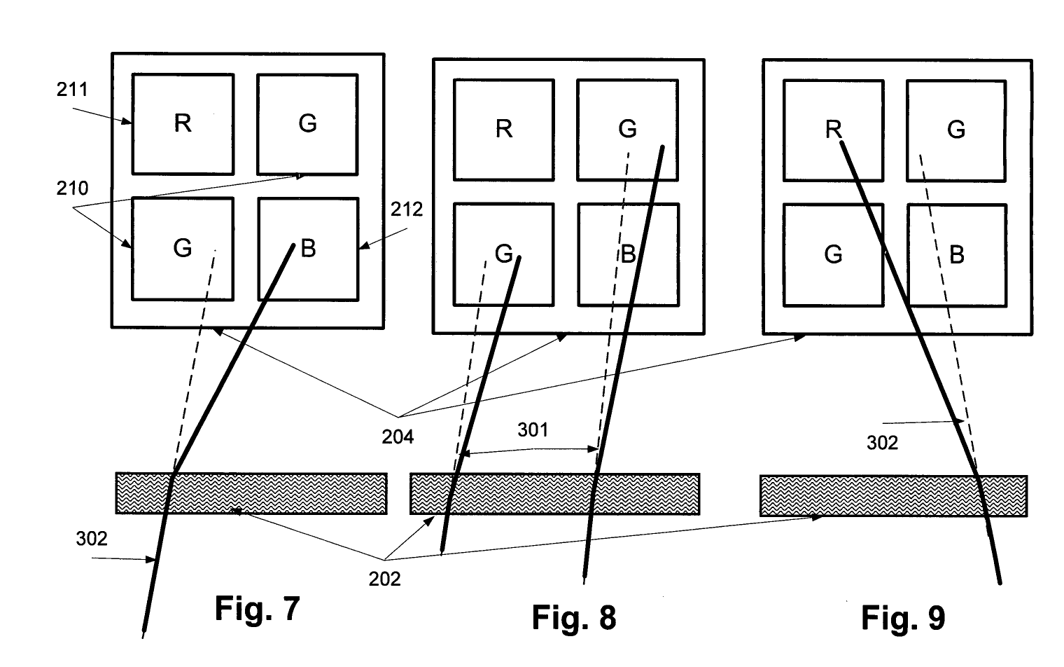

Reference is now also made to FIGS. 7, 8, and 9, each is a schematic illustration of one of the exemplary diffractive optics sub-elements, which are depicted in FIG. 6, and a respective 2×2 array of light-sensitive elements 204 of the image sensor 101, according to one embodiment of the present invention. In the exemplary embodiment, the image sensor 101 is patterned according to a Bayer mosaic pattern layout, as described above.

As shown in FIGS. 7, 8, and 9 and described above, the diffractive optics sub-element 202 redirects a light wave according to its wavelength. Optionally, the diffractive optics sub-element 202 is divided to three areas. The first area is a green light diffracting area that is positioned in front of light-sensitive elements which are assigned to measure blue and/or red light waves. The second area is a red light diffracting area that is positioned in front of one or more light-sensitive elements, which are assigned to measure green and/or blue light waves. The third area is blue light diffracting area that is positioned in front of one or more light-sensitive elements which assigned to measure green and/or red light waves.

In use, whenever green light impinges the red and/or the blue light diffracting areas, as shown at 301, it passes therethrough, toward the light-sensitive elements which are positioned there in front and/or assigned to measure green light waves. Whenever red and/or blue light impinges the green diffracting areas, as shown at 302, they are redirected to one or more of the neighboring light-sensitive elements which are assigned to measure green light waves. If the impinging light is red, it is redirected to a blue and/or green neighboring light-sensitive elements and if the impinging light is blue, it is redirected to neighboring light-sensitive elements, which assigned to measure green and/or red light waves. Optionally, whenever green light impinges the green light diffracting areas, it is redirected to one or more of the neighboring light-sensitive elements, which assigned to measure red and/or blue light waves.

Optionally, each light-sensitive element is associated with a sub-pixel and each 2×2 array is associated with a pixel.

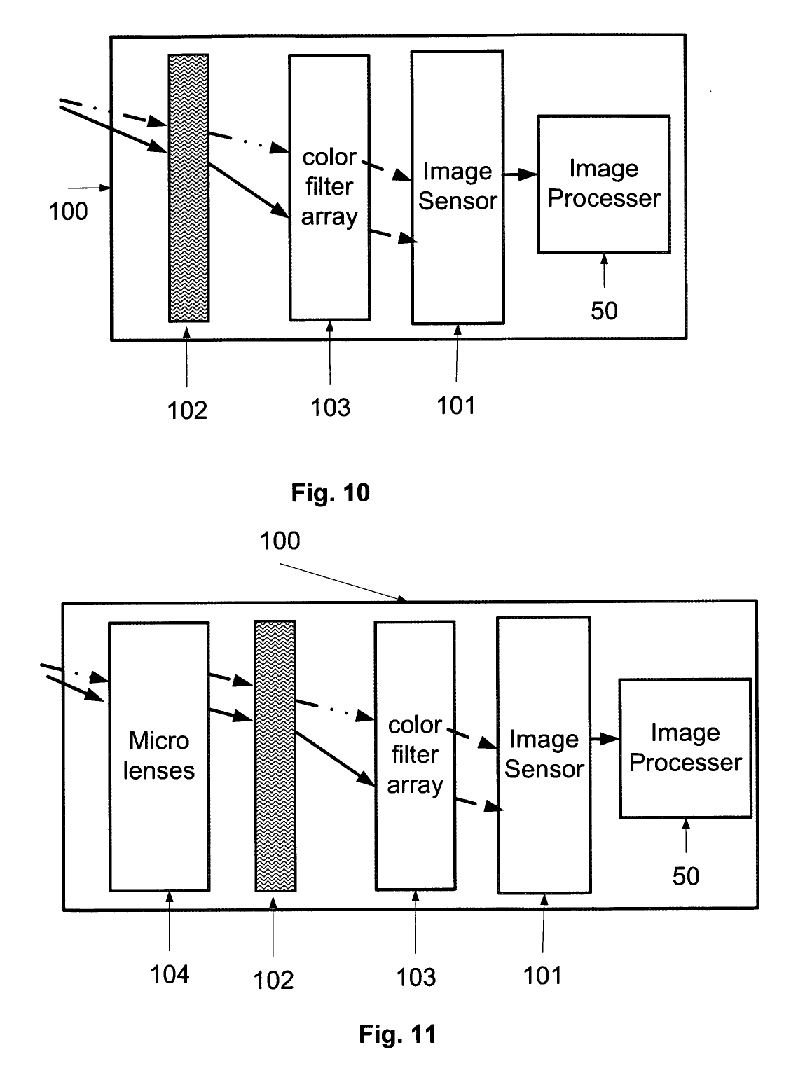

Reference is now also made to FIG. 10, which is a sectional schematic illustration of an image capturing device 100 for capturing a digital image, according to one embodiment of the present invention. The image sensor 101 and the DOE 102 are as depicted in FIG. 4, however FIG. 10 further depicts a filter, such as a band pass filter (BPF) or a color filter array (CFA) 103, which is optionally positioned between the DOE 102 and the image sensor 101.

The filter 103, which is optionally a Bayer filter mosaic, filters out impinging light waves according to one or more of their characteristics, for example according to their wavelength. Optionally, the filtering array 103 includes a matrix of filtering elements each associated with one or more of the light-sensitive elements of the image sensor 101. Optionally, each filtering element allows incident light waves of a predefined wavelength range to pass therethrough toward the associated light-sensitive element. For example, the filtering element allows incident light waves of the wavelength of nothing but red (R) light, nothing but green (G) light or nothing but (B) blue light. For each light-sensitive element, it therefore detects only one of the three primary components (R, G, and B) of additive chromatic synthesis.

As described above, the DOE 102 is designed to diffract light having different wavelengths toward different light-sensitive elements. Such an embodiment allows the absorption of color photons, which are directed to an area in which they will either be filtered out or ignored by redirecting them toward a neighboring area. The absorption of redirected photons is performed in parallel to the absorption of direct photons, which are not filtered out or ignored. As the image sensor 101 receives the redirect and direct photons, the light intensity of the image it captures is increased in relation to an image that it would have captured after some of the photons would have been filtered out. As a quality of an image is determined, inter alia, by the level of the light intensity, the absorption of the redirected photons improves the quality of captured images.

Optionally, each pixel is associated with an array of 2×2 light-sensitive elements.

Optionally, the filter 103 is defined according to the diffraction of the DOE 102. In such an embodiment, the pattern of the filter 103 is determined according to the DOE 102 and therefore not bounded to any of the known patterns. As described above, avoiding the filtering may improve the quality of captured images, for example by increasing the intensity of light that is captured by the image sensor 101. However, such avoidance may also have disadvantages. For example, such avoidance may reduce the resolution of the captured images. In order to balance between the advantages and disadvantages of the filtering, an adjusted filter that filters only light that is centered on one or more wavelengths, or light is about to impinge some of the light-sensitive elements, may be used. Optionally, the filter 103, which is designed according to the DOE 102, is adapted to filter incident light waves centered on the green wavelength and directed and/or diffracted toward light-sensitive elements, which are designated to measure the intensity of incident light waves centered on the blue and/or the red wavelengths. For clarity, when an adapted filter is used, some of the incident light waves arrive to the light-sensitive elements after being diffracted by the DOE 102, after passing via the filter 103, or after both.

Reference is now also made to FIG. 11, which is a sectional schematic illustration of an image capturing device 100 for capturing a digital image, according to one embodiment of the present invention. The image sensor 101, the DOE 102, and the filter 103 are as depicted in FIG. 10, however FIG. 11 further depicts a set of microlenses 104, which is optionally positioned in front of the DOE 102.

As described above, the light-sensitive elements of the image sensor 1 may not be attached to one another and therefore may not cover the entire surface of the image sensor. In such an embodiment, a set of microlenses 104 may used to redirect impinging light waves, which would otherwise impinge the unsensing areas, toward sensing areas. Optionally, a microlens is a small spherical or aspheric lenslet. The microlenses direct photons which are about to hit the unsensing areas of the image sensor 101 toward its photosensitive cells. Usually an array of microlenses is used for the array of light-sensitive elements. Each lenslet in a set of microlenses produces its own output pattern according to its aperture dimensions, surface curvature, and the divergence of the incoming light from the source. Optionally, an impinging light wave is redirected according its wavelength. In such a manner, green light is redirected toward blue and/or to red diffracting areas, red light is redirected toward blue and/or to green diffracting areas, and blue light is redirected toward green and/or to red diffracting areas.

The DOE microlenses may be added to an embodiment without the filter 103 wherein the light is not filtered but only diffracted.

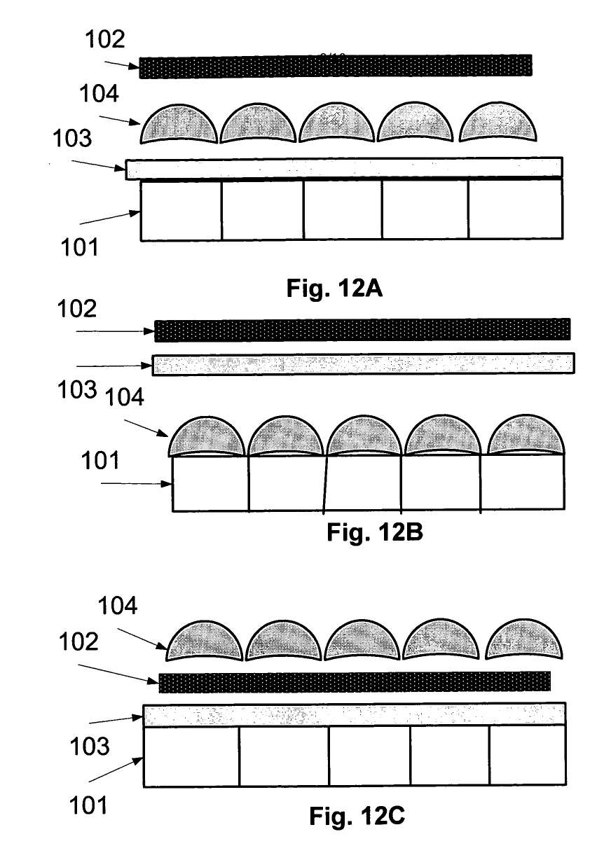

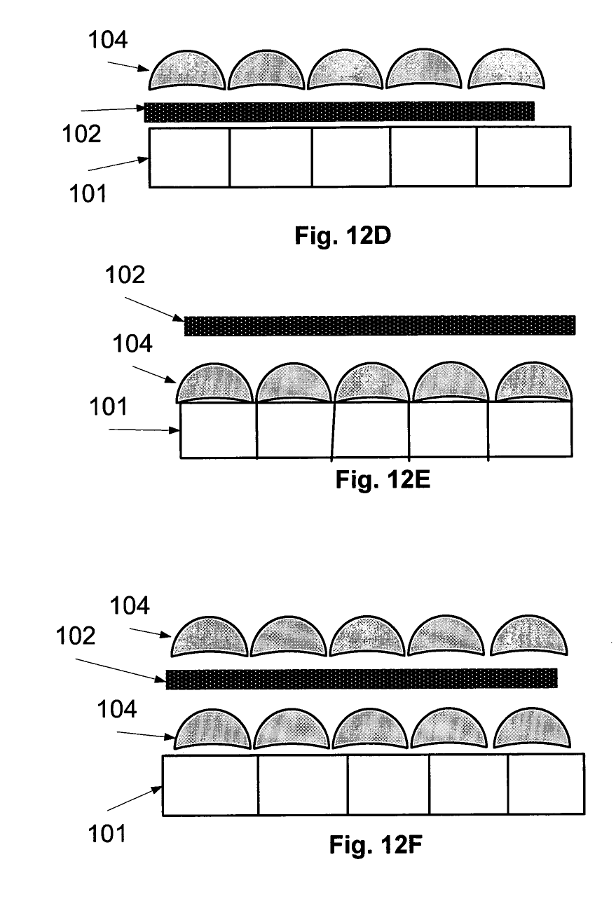

For clarity, it should be noted that the set of microlenses 104 may be positioned, between, below, or above the filter 103 and the DOE 102, for example as respectively depicted in FIGS. 12A-C, which are schematic lateral illustrations of these components, according to some embodiments of the present invention.

In one embodiment of the present invention, the image capturing device 100 comprises only the image sensor 101, the DOE 102, and the set of microlenses 104, for example as depicted in FIGS. 12D-12F, which are schematic lateral illustrations of these components. In such an embodiment, the DOE 102 diffracts light in a manner that reduces the need for using filters, such as CFAs. As such filtering may reduce the light intensity of the image that is captured by the image sensor 101, avoiding the filtering may improve the quality of the captured images, optionally as described above. The set of microlenses 104 may be positioned above the DOE 102, for example as shown at 12D, below the DOE 102, for example as shown at 12E, or both, as shown at 12F. It should be noted that while the set of microlenses 104 may be more effective when it is positioned below the DOE 102, the positioning thereof above the DOE 102 may facilitate the calibration of the image capturing device 100.

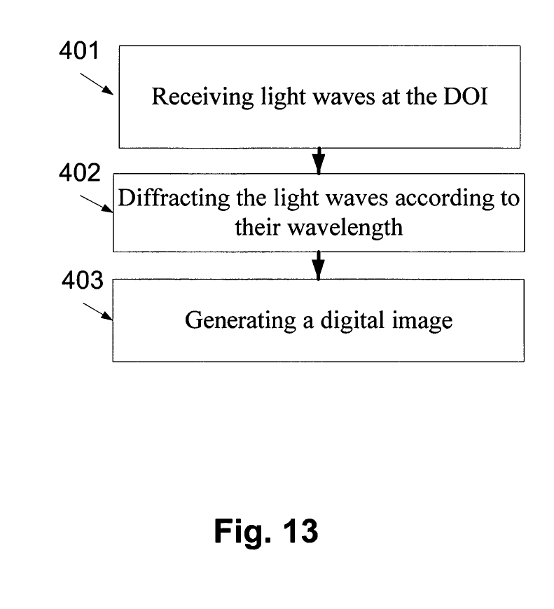

Reference is now also made to FIG. 13, which is a flowchart of a method for capturing a digital image, according to one embodiment of the present invention.

During the first step, as shown at 401, a number of light waves impinge an image plane that is formed on the DOE. Then, as shown at 402, the DOE diffracts one or more of the impinging light waves toward one or more of the light-sensitive elements of the image sensor. The impinging light waves are diffracted toward light-sensitive elements which are designed to measure impinging light waves and to output values that corresponds to the intensity of the received light. After the light waves have been diffracted toward the light-sensitive elements according to their wavelength, a digital image is generated, as shown at 403. The digital image is generated according to the diffracted light waves, which have been captured by the light-sensitive elements. In should be noted that as some of the light waves, which have been measured by the light-sensitive elements, have been redirected from other light-sensitive elements and/or from an unsensing area, as described above, more light waves are measured by the image sensor. As more light waves are measured, the quality of the generated image is higher in relation to the quality of a respective image that could have been generated based on direct light waves only.

It is expected that during the life of this patent many relevant devices and systems will be developed and the scope of the terms herein, particularly of the terms filter and image sensor are intended to include all such new technologies a priori.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable subcombination.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims. All publications, patents, and patent applications mentioned in this specification are herein incorporated in their entirety by reference into the specification, to the same extent as if each individual publication, patent or patent application was specifically and individually indicated to be incorporated herein by reference. In addition, citation or identification of any reference in this application shall not be construed as an admission that such reference is available as prior art to the present invention.

What is claimed is:

1. An apparatus for generating a color image, comprising:
an image sensor having a plurality of light-sensitive elements each configured for measuring a value corresponding to an intensity of light at a respective light sensing area;
a diffractive optics element configured for diffracting impinging light waves, each said impinging light wave being diffracted according to its wavelength toward at least one of said light-sensitive elements; and
an image processor configured for generating a color image by arranging said values.

2. The apparatus of claim 1, wherein said diffractive optics element having an image plane and configured for diffracting light waves impinging said image plane, said color image depicting said image plane.

3. The apparatus of claim 1, wherein the thickness of said diffractive optics element is thinner than 3 millimeters.

4. The apparatus of claim 1, wherein said diffractive optics element is fixated to said image sensor in front of said plurality of light-sensitive elements.

5. The apparatus of claim 1, wherein each said intensity of light having a member of the following group: a wavelength in the red spectrum, a wavelength in the blue spectrum, and a wavelength in the green spectrum.

6. The apparatus of claim 1, wherein said diffracted impinging light wave is unfiltered.

7. The apparatus of claim 1, further comprises a first set of microlenses for diffracting a light wave that would otherwise impinge an unsensing area toward one of said respective light sensing areas, said first set of microlenses is positioned in a member of group consisting of: between said diffractive optics element and said image sensor or above said diffractive optics element.

8. The apparatus of claim 7, further comprising a second set of microlenses, said first and second sets of microlenses are respectively positioned above and below said diffractive optics element.

9. The apparatus of claim 1, further comprises a mosaic filter for filtering at least some of said impinging light waves according to its wavelength, said mosaic filter is positioned in a member of group consisting of: between said diffractive optics element and said image sensor or above said diffractive optics element.

10. The apparatus of claim 9, wherein the pattern of said mosaic filter is designed according to the diffracting of said diffractive optics element.

11. The apparatus of claim 1, wherein the apparatus is a mobile phone.

12. The apparatus of claim 1, wherein each said light-sensitive element is assigned to measure intensity of light in a predefined range of color spectrum.

13. The apparatus of claim 12, wherein each said impinging light wave is centered on a certain wavelength and diffracted toward the proximate light-sensitive element which is designated to measure light in said certain wavelength.

14. The apparatus of claim 1, wherein said impinging light wave is directed toward unsensing area in said image sensor.

15. The apparatus of claim 1, wherein said plurality of light-sensitive elements are divided to a plurality of arrays, said diffractive optics element including a grid of sub-elements each designed for diffracting said impinging light wave toward a member of one of said arrays according to said wavelength.

16. The apparatus of claim 15, wherein said impinging light wave is directed toward a member of a first of said plurality of arrays, said respective sub-element being configured for diffracting said impinging light wave toward another member of said first array, said another member being assigned to measure said wavelength.

17. A method for capturing a digital image, comprising:
receiving a light wave impinging an image plane;
diffracting said impinging light wave toward a reception thereof by one of a plurality of light-sensitive elements, said impinging light wave being diffracted according its wavelength;
measuring an intensity of light having said wavelength at said receiving light-sensitive element; and
outputting a digital image of said image plane according to said measurement.

18. The method of claim 17, wherein each said light-sensitive element is assigned to measure intensity of light in a predefined range of color spectrum.

19. The method of claim 18, wherein each said impinging light wave is centered on a certain wavelength, said diffracting comprising diffracting said impinging light wave toward the proximate light-sensitive element which is designated to measure light in said certain wavelength.

20. The method of claim 17, wherein said diffracting comprising diffracting a light wave that would otherwise impinge an unsensing area toward one of the plurality of light-sensitive elements.

21. An image sensor, comprising:
an array of a plurality of light-sensitive elements; and
a diffractive optics element having an image plane and configured for diffracting impinging light waves to form an arrangement of illumination areas on said array;
wherein each said illumination area has a wavelength in a predefined range of color and corresponds with a point in said image plane and with at least one of said plurality of light-sensitive elements;
wherein said arrangement has a repetitive pattern including a group of said illumination areas having a different said predefined range.

22. The image sensor of claim 21, wherein said diffractive optics element is fixated in front of said light-sensitive elements.

23. The image sensor of claim 21, wherein said arrangement is arranged according to a Bayer filter mosaic.

24. The image sensor of claim 21, wherein said plurality of light-sensitive elements are arranged in a predefined mosaic and configured to measure an intensity of light received in their light sensing area, further comprising an image processing unit configured for generating a digital image by demosaicing said predefined mosaic.

25. A light deviation array for diffracting a plurality of impinging light waves toward an image sensor having a plurality of light-sensitive elements, comprising:
a plurality of diffractive optics sub-elements superposed in one-to-one registry on arrays from the plurality of light-sensitive elements, each said diffractive optics sub-element being configured for diffracting a plurality of impinging light waves toward a respective said array;
wherein said impinging light wave is directed toward a member of a first of said array, said respective sub-element being configured for diffracting said impinging light wave toward another member of said array.

26. The light deviation array of claim 25, wherein each member of said array is configured for measuring an intensity of light having a member of the following group: a wavelength in the red spectrum, a wavelength in the blue spectrum, and a wavelength in the green spectrum.
